(19) United States
(12) Patent Application Publication
(10) Pub. No.: US 2007/0239794 A1
(43) Pub. Date: Oct. 11, 2007

(54) Method and system for updating logical information in databases

(75) Inventor: Donald F. Metzner, Lyons, CO (US)

Correspondence Address: BAKER BOTTS L.L.P., 2001 ROSS AVENUE, SUITE 600, DALLAS, TX, 75201-2980, US

(73) Assignee: COMPUTER ASSOCIATES THINK, INC.

(21) Appl. No.: 11/399,035

(22) Filed: Apr. 5, 2006

(51) Int. Cl. G06F 17/30

(52) U.S. Cl. 707/200

(57) ABSTRACT

A method for updating logical relationship information describing one or more defined logical relationships among a plurality of segments of one or more databases includes accessing the logical relationship information and establishing a plurality of updates corresponding to the one or more defined logical relationships. The plurality of segments includes a first segment and a second segment of the one or more databases. The defined logical relationship represents a logical relationship between the first segment and the second segment. A segment comprises a unit of information of a database of the one or more databases. An update is operable to update the logical relationship information. The method also includes automatically performing the following in parallel in response to establishing the plurality of updates, the automatic performance encoded in software, updating the logical relationship information using the plurality of updates corresponding to the one or more defined logical relationships.

### TECHNICAL FIELD

This invention relates generally to the field of database management, and more specifically to a method and system for updating logical information in databases.

### BACKGROUND

Information Management System (IMS) databases are hierarchical databases used in database management systems. IMS databases typically include segments that may include logical and physical relationship information. Logical relationship information may describe logical relationships among segments of one or more databases.

Logical relationship information may be established and maintained by “prefix resolution” and “prefix update.” Prefix resolution identifies segments of the databases that need to be updated and determines the updates required to update the relationship information of the databases. Prefix update processes the updates to update the relationship information.

### SUMMARY OF THE DISCLOSURE

In accordance with the present invention, disadvantages and problems associated with previous techniques for updating logical information in databases may be reduced or eliminated.

In accordance with a particular embodiment, a method may be provided for updating logical relationship information describing defined logical relationships among segments of databases. In this embodiment, the segments may include a first segment and a second segment where a segment may be a unit of information of a database. In this embodiment, a defined logical relationship may represent the logical relationship between the first and the second segment. The method of this embodiment may include accessing logical relationship information. The method may further include establishing updates corresponding to the defined logical relationships. Updates operate to update logical relationship information. In response to establishing updates, this method may also automatically, in parallel, update the logical relationship information using the updates corresponding to the defined logical relationships. Updating of the logical relationship information may be encoded in software.

Certain embodiments of the invention may provide one or more technical advantages. A technical advantage of one embodiment may be that updates are automatically processed in parallel. Another technical advantage of one embodiment may be that the update process can be controlled by sorting and processing parameters. Another technical advantage of one embodiment may be that the system may know when the update process is complete allowing for easier automation of processes.

Certain embodiments of the invention may include none, some, or all of the above technical advantages. One or more other technical advantages may be readily apparent to one skilled in the art from the figures, descriptions, and claims included herein. Moreover, while specific advantages have been enumerated above, various embodiments may include all, some or none of the enumerated advantages.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of a system for updating logical relationships in databases, in accordance with a particular embodiment of the present invention;

FIG. 2 is a block diagram of physical and logical relationship pointers between segments in the first and second databases, in accordance with a particular embodiment of the present invention;

FIG. 3 is a block diagram of a general update file sorted by dataset group including update sets for dataset groups B, C, and X, in accordance with a particular embodiment of the present invention; and

FIG. 4 is a flowchart of a method for updating logical relationship information describing logical relationships among segments of one or more databases, in accordance with a particular embodiment of the present invention.

### DETAILED DESCRIPTION OF THE DRAWINGS

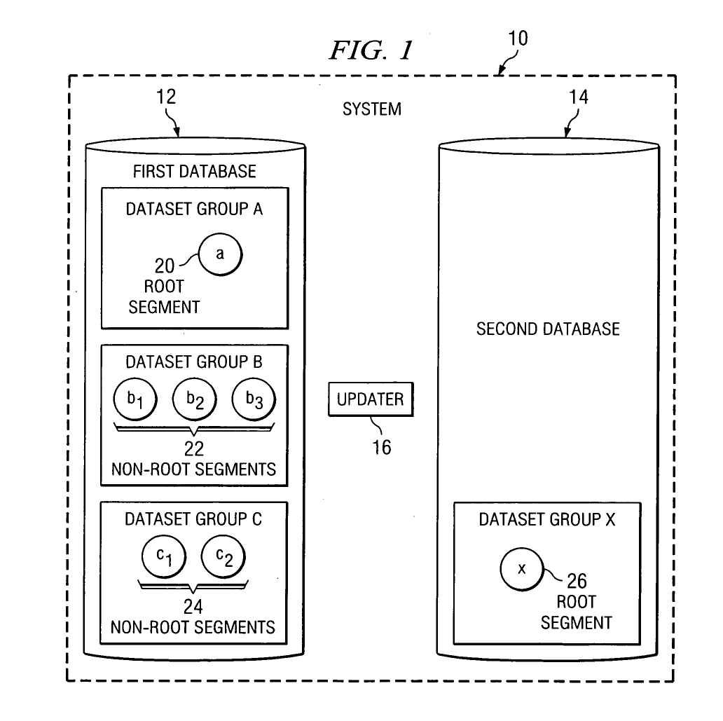

Embodiments of the present invention and its advantages are best understood by referring to FIGS. 1 through 4 of the drawings, like numerals beings used for like and corresponding parts of the various drawings.

FIG. 1 is a block diagram of a system 10 for updating logical relationships in databases, in accordance with a particular embodiment of the present invention. In the illustrated embodiment, system 10 includes a first database 12, a second database 14, and an updater 16. In a particular embodiment, system 10 may load database 12 and database 14. Updater 16 may refer to a microprocessor, controller, or any other suitable computing device, resource, or combination of hardware, software and/or encoded logic. In this embodiment, updater 16 of system 10 may automatically update, in parallel, the logical relationship information of the databases. In some embodiments, system 10 may sort the updates of logical information using predefined system parameters and/or user parameters. In some other embodiments, system 10 may also notify the user that the update process has started and has completed. In certain embodiments, system 10 may be a database management system.

Parallel updating may be more efficient than automatic sequential updating or manually parallel updating. Thus, particular embodiments of this system provide an improved update process that is more efficient, which saves computing resources.

In the illustrated embodiment, system 10 includes databases 12 and 14. It should be understood that system 10 in accordance with various embodiments may be associated with any suitable number of databases.

According to one embodiment, a “database” refers to any hardware, software, firmware, or combination of the preceding for storing and facilitating retrieval of information. In particular embodiments, databases 12 and 14 comprise information management system (IMS) databases. According to one embodiment, “IMS database” refers to a hierarchical database used by an IMS database management system. According to one embodiment, a hierarchical database is a database that maps relationships between segments in a tree-like data structure. A database may use any of a variety of data structures, arrangements, and compilations to store and facilitate retrieval of information.

In particular embodiments, a database may comprise at least one dataset group. In some cases, a database may include ten or fewer dataset groups. In the illustrated embodiment, first database 12 includes dataset group A, dataset group B, and dataset group C. Second database 14 includes dataset group X. According to one embodiment, a “dataset group” refers to a subset of a database comprising a collection of segments of one or more types. According to one embodiment, a “segment” refers to the smallest amount of data that can be transferred by one operation of system 10. Any suitable segments may be used that are appropriate to the information in the databases. A segment may be identified by a segment key.

In some cases, each dataset group may contain only one type of segment. A root segment may refer to the first or highest segment in the database hierarchy. A non-root segment may refer to all other segments of the database hierarchy. In the illustrated embodiment, dataset group A includes a root segment 20 such as segment a; dataset group B includes non-root segments 22 such as segments b₁, b₂, and b₃; and dataset group C includes non-root segments 24 such as segments c₁ and c₂. Dataset group X includes a root segment 26 such as segment x.

In particular embodiments, each segment may include a prefix. A prefix may refer to data preceding other segment data. In one embodiment, the prefix may store relationship information describing the relationship of the segment to other segments in the database. In this embodiment, the prefix update process may update the prefix to correspond to new relationship information. In one case, updater 16 may include a prefix update processor to perform the prefix update process. In another embodiment, the prefix may contain a physical address of a logically related segment. In this embodiment, the prefix update process may change the prefix to reflect a new address of the logically related segment.

In some embodiments, segments may have segment addresses. According to one embodiment, a “segment address” describes the physical location of a segment in a database. In some embodiments, each segment may have a relative byte address (RBA). For example, a “relative byte address” of a segment may refer to an indicator of how many bytes into the database the segment is located.

According to one embodiment, the root segment is the ancestor of all the non-root segments in the database. Non-root segments may reference the root segment as part of their identity.

One or more components of system 10 may include appropriate input devices, output devices, mass storage media, processors, memory, or other components for receiving, processing, storing, and communicating information according to the operation of the system. As an example, one or more components of the system may include logic, interface, memory, other component, or any suitable combination of the preceding. According to one embodiment, “logic” may refer to hardware, software, other logic, or any suitable combination of the preceding. Certain logic may manage the operation of a device, and may comprise, for example, a processor. According to one embodiment, “processor” may refer to any suitable device operable to execute instructions and manipulate data to perform operations.

According to one embodiment, “interface” may refer to logic of a device operable to receive input for the device, send output from the device, perform suitable processing of the input or output or both, or any combination of the preceding, and may comprise one or more ports, conversion software, or both. According to one embodiment, “memory” may refer to logic operable to store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Modifications, additions, or omissions may be made to system 10 without departing from the scope of the invention. The components of system 10 may be integrated or separated according to particular needs. Moreover, the operations of system 10 may be performed by more, fewer, or other modules. Additionally, operations of the system 10 may be performed using any suitable logic comprising software, hardware, other logic, or any suitable combination of the preceding. According to one embodiment, “each” may refer to each member of a set or each member of a subset of a set.

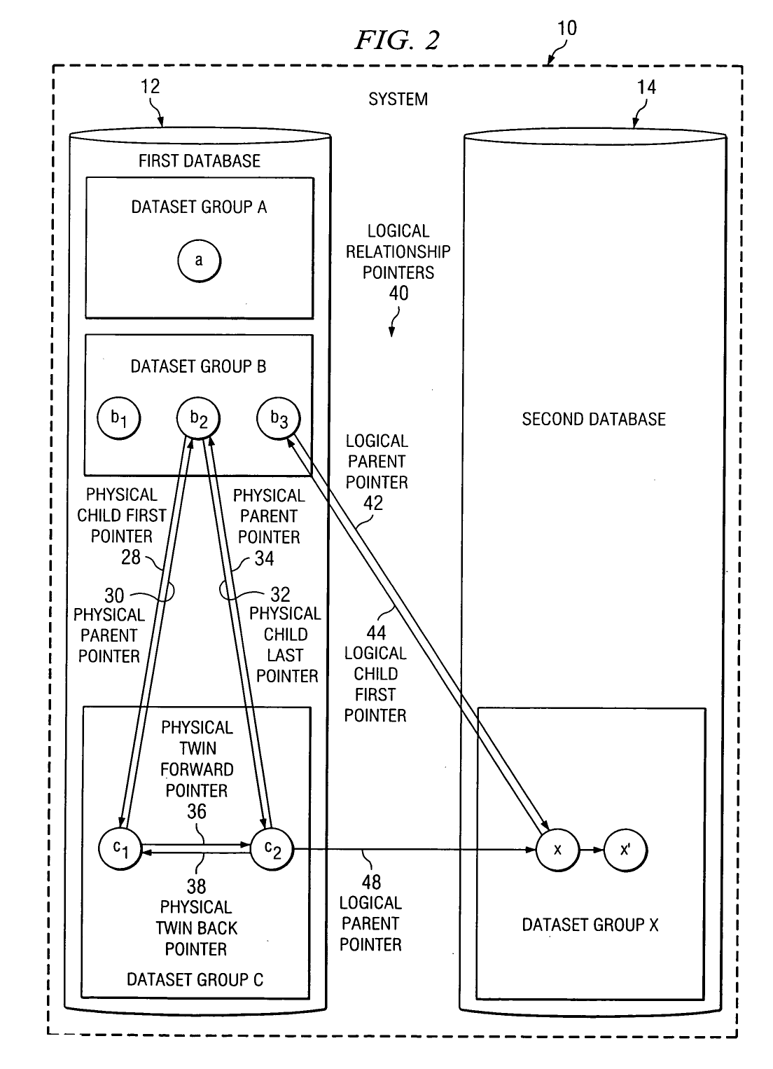

FIG. 2 is a block diagram of one embodiment of physical and logical relationship pointers between segments of first database 12 and second database 14. According to the illustrated embodiment, a “relationship pointer” refers to an indicator of the relationship information between two segments in one or more databases. A relationship pointer may be pictorially represented by arrows pointing from a first segment to a second segment.

According to some embodiments, “relationship information” refers to any information describing a hierarchical or other relationship between segments of one or more databases. Relationship information may include defined relationship information and/or undefined relationship information. In one embodiment, defined relationship information may refer to relationship information that has been defined before the prefix resolution process. Relationship information may also include logical relationship information and/or physical relationship information. In one embodiment, logical relationship information may refer to any information describing the logical relationship between two or more segments in one or more databases. For example, logical relationship information may describe a logical parent-child relationship between segments. In another embodiment, physical relationship information may refer to any information describing the physical relationship between two or more segments in one database.

In one example, first database 12 may describe cars, and second database 14 may describe people. In this example, segments in dataset group A may describe car types. Segment a of dataset group A may be identified by a key designating a model of a car, such as a Camaro. The segments in dataset group B may describe particular cars, where each car is identified by a key designating a vehicle identification number. For example, a key of segment b₁ may be VIN1, a key of segment b₂ may be VIN2, and a key of segment b₃ may be VIN3. In this example, the segments in dataset group C may describe previous owners. In this example, the segments in dataset group C may be identified by a key designating the social security number of the previous owner. For example, the key of c₁ may be SSN1 and c₂ may be SSN2. In this example, dataset group X may describe particular people. Segment x of dataset group X may be identified by a key designating a social security number of particular people.

Physical relationship pointers may indicate the physical relationship between segments of one database. In the illustrated embodiment, physical relationship pointers 28, 30, 32, 34, 36, and 38 indicate a physical relationship of a second segment to a first segment. For example, physical child pointer 28 pointing from segment b₂ to segment c₁ indicates that segment c₁ is the child of parent segment b₂.

Some examples of physical relationship pointers are physical child first (PCF), physical child last (PCL), physical twin forward (PTF), physical twin backward (PTB), and physical parent (PP). A PP relationship pointer points from a child segment back to a parent segment. In the illustrated embodiment, a physical parent (PP) pointer 30 points from c₁ to b₂, indicating that segment b₂ is the parent segment of child segment c₁. Also, a PP pointer 34 points from c₂ to b₂, indicating that segment b₂ is the parent of child segment c₂.

Physical children segments related to a parent segment are linked together in a chain. The PCF, PCL, PTF, and PTB relationship pointers indicate the location of the children in the chain. A PCF relationship pointer points from a parent segment to a first child segment in the chain. A PCL relationship pointer points from a parent segment to a last child segment in the chain. In the illustrated embodiment, a PCF pointer 28 points from b₂ to c₁, indicating that segment c₁ is the first child segment of the parent segment b₂. Also, a PCL pointer 32 points from b₂ to c₂, indicating that segment c₂ is the last child of parent segment b₂. PTF and PTB relationship pointers link the children along the chain by pointing from one child segment to the next (for PTF) or previous (for PTB) child segment in the chain. In the illustrated embodiment, a physical twin back (PTB) pointer 38 points from c₂ to c₁, indicating that segment c₁ is the previous twin to segment C₂. A physical twin forward (PTF) pointer 36 points from c₁ to c₂, indicating that segment c₂ is the next twin after segment c₁.

Logical relationship pointers may indicate the logical relationship between two segments in one or more databases. In the illustrated embodiment, logical relationship pointers 40 indicate the logical relationship of a second segment to a first segment.

Examples of logical relationship pointers may include logical child first (LCF), logical child last (LCL), logical twin forward (LTF), logical twin backward (LTB), and logical parent (LP). A LP pointer points from a logical child segment back to a logical parent segment. In the illustrated embodiment, a logical parent (LP) pointer 42 points from logical child segment b₃ to logical parent segment x, indicating that segment x of second database 14 is the logical parent of segment b₃ of first database 12. Also, a LP pointer 48 points from logical child segment c₂ to logical parent segment x, indicating that segment x of second database 14 is the logical parent of segment c₂ of first database 12.

A LCF pointer points from a logical parent segment to a first logical child segment. A LCL pointer points from a logical parent segment to a last logical child segment. In the illustrated embodiment, a logical child (LC) first pointer 44 points from logical parent segment x to logical child segment b₃ indicating that segment b₃ of first database 12 is the logical child of segment x of second database 14.

In some embodiments, logical parents do not have LCF, or LCL pointers back to their logical children. Logical parents that do not have LCF or. LCL pointers to their logical children, may alternatively have a child counter (CTR). The CTR of a segment tracks the number of logical children that have the segment as a logical parent and are not pointed to by logical child pointers.

In the illustrated embodiment, segment c₂ is a logical child of segment x and is not pointed to by a logical child pointer from segment x. In this case, segment x would have a child counter of 1 indicating that segment c₂ is a logical child of segment x without a logical child pointer indicating the logical relationship.

Relationship information may be stored as a concatenated key. A concatenated key may be described as a path through segment keys in the database(s) to get to a particular segment. In the car example from above, the concatenated key of segment c₂ is Camaro-VIN2-SSN2. In this case, segment c₂ may be located by following a path through first database 12 from the key of segment a Camaro to the key of segment b₂ VIN2 to the key of segment c₂ SSN2. In addition, logical child segments may follow the path of keys in their logical parent concatenated key (LPCK) to identify their logical parent. In the car example from above, logical child c₂ with a concatenated key of Camaro-VIN2-SSN2 may locate its logical parent using its LPCK that identifies its logical parent x. In some embodiments, the logical child does not store its LPCK in the segment but instead, stores the RBA of its logical parent in the segment prefix. In some embodiments, both the LPCK and a LP pointer are used.

In particular embodiments, relationship information may be resolved and updated to indicate valid physical addresses of related segments. As an example, physical addresses may change during database reorganization. Changing physical addresses may invalidate relationship information referencing the changed physical addresses. In the illustrated embodiment, the physical address of segment x of dataset group X changed from x to x′. The defined relationship information of related segments is no longer valid and needs to be updated to indicate new address x′. For example, when segment x moved from x to x′, logical information indicated by logical parent pointers 42 and 48 needs to be updated to correctly indicate new address x′.

In particular embodiments, correcting relationship information may be accomplished by a process that includes prefix resolution and prefix update. According to one embodiment, “prefix resolution” refers to the process of determining the updates required to yield correct logical relationship pointers and counters. According to one embodiment, an “update” is a record in a workfile that is used to describe the updates to the logical relationship pointers and counters for one segment in the databases. According to one embodiment, “prefix update” refers to the process of applying those updates to the databases.

In particular embodiments, reorganizing databases may create a plurality of workfiles that include descriptions of the location of logically related segments. According to one embodiment, a “workfile” refers to a temporary repository of data stored in a file or retained in memory. In particular embodiments, a workfile may include dataset and database identifiers, the RBA of the segment, and updates of relationship information.

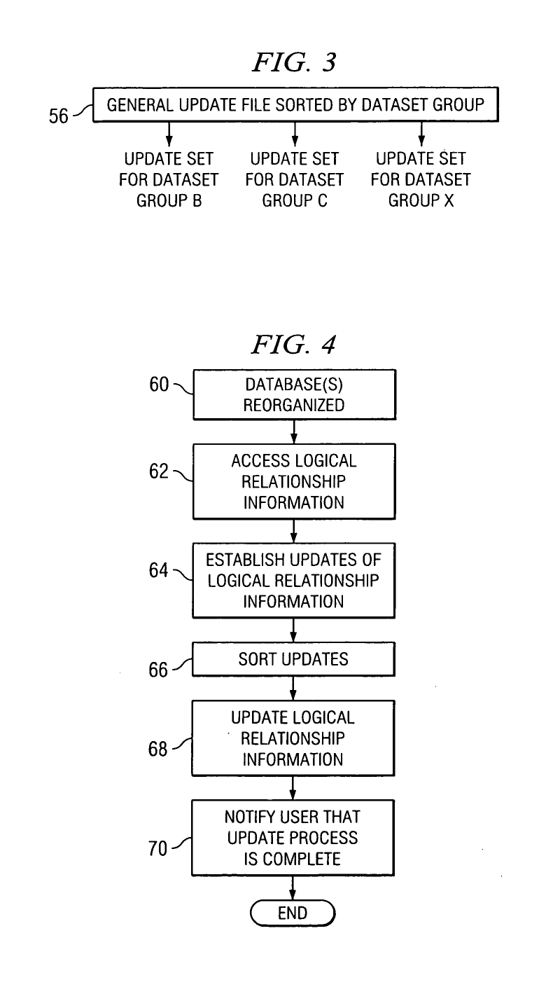

FIG. 3 is a block diagram of one embodiment of a general update file 56 including update sets for dataset groups B, C, and X of FIG. 2. In some cases, the updates from general update file 56 may be directly input into prefix update process. In other cases, general update file 56 may be sorted, and select update sets may be extracted from general update file 56 to input into the prefix update process.

In the illustrated embodiment, an update set for dataset group B, an update set for dataset group C, and an update set for dataset group X are extracted from general update file 56. According to one embodiment, general update file 56 is sorted into dataset group order by prefix resolution. Once sorted by dataset group, update sets for each dataset group may be extracted from general update file 56. Sorting by dataset group may allow for more efficient extraction of updates based on dataset group.

Once extracted, a prefix update processor of updater 16 may process, in parallel, the update sets in prefix update. In some cases, the prefix update processor of updater 16 may automatically process the update sets. In other cases, the user may choose to control the update process by defining process parameters. For example, the user may select only those update sets associated with one database to expedite updating the one database.

FIG. 4 is a flowchart illustrating a method for updating logical relationship information describing logical relationships among segments of one or more databases, in accordance with a particular embodiment. In some cases, one or more of the steps of the method may be encoded in software. In some cases, one or more of the steps of the method are part of a maintenance operation. This method may be performed by updater 16 of system 10 or by another module of system 10. In one case, system 10 may use the prefix update processor of updater 16 to perform the method of updating.

The method begins at step 60, when one or more of the databases are reorganized. In particular embodiments, physical addresses of the segments may change during reorganization. When physical addresses change, logical relationship information referencing the physical addresses may no longer be valid, and the logical relationship information may need to be updated.

At step 62, the logical relationship information in the databases is accessed. In particular embodiments, the accessed logical relationship information may describe the defined logical relationships among segments in the databases.

At step 64, updates of logical relationship information are established. In particular embodiments, updated logical relationship information corresponding to the accessed defined logical relationships may be established. In one embodiment, each update may correspond to a defined logical relationship between a first and second segment of the databases. For example, system 10 may establish updates to the logical relationship information that reflect the new address x′ of segment x illustrated in FIG. 2. In particular embodiments, a new address for a segment is received, the defined logical relationship associated with the segment is identified, and the updated logical relationship information corresponding to the defined logical relationship is generated. In the illustrated embodiment, system 10 may receive a new address x′ for x. System 10 may then identify logical pointer 42 associated with segment x and generate a new logical pointer 42 that points to x′. System 10 may perform a similar operation for logical pointer 48.

At step 66, updates of logical relationship information are sorted. In particular embodiments, updates of logical relationship information may be found in one or more workfiles. In some cases, the updates of logical relationship information in the concatenated file may be sorted by dataset group resulting in a general update file. In these cases, update sets may be extracted from the general update file so that each update set contains the updated logical relationship information for a dataset group. In one case, the user may control the sorting by user parameters. In another case, the updates are sorted by predefined system parameters.

At step 68, logical relationship information is updated using the established updates. In some cases, updating logical relationship information may be initiated in response to establishing plurality of updates. In these cases, the system may automatically process the updates in parallel. In these cases, the automatic performance may be encoded in software. In particular embodiments, updating logical relationship information may further comprise identifying prefix indicating the logical relationship information and changing the prefix in accordance with the updated logical information. The prefix update processor or other system module may update logical relationship information corresponding to the invalid physical address x to reflect the new valid address x′. In particular embodiments, to update the logical relationship information, the logical relationship information indicated in the prefix may be identified and the prefix may be changed to reflect the new address of the second segment. At step 70, the user is notified that the update step is complete.

Modifications, additions, or omissions may be made to the method without departing from the scope of the invention. The method may include more, fewer, or other steps. Additionally, steps may be performed in any suitable order without departing from the scope of the invention.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for updating logical relationship information describing one or more defined logical relationships among a plurality of segments of one or more databases, comprising:
accessing the logical relationship information describing the one or more defined logical relationships among the plurality of segments of the one or more databases, the plurality of segments comprising a first segment and a second segment of the one or more databases, a defined logical relationship representing a logical relationship between the first segment and the second segment, a segment comprising a unit of information of a database of the one or more databases;
establishing a plurality of updates corresponding to the one or more defined logical relationships, an update operable to update the logical relationship information; and
automatically performing the following in parallel in response to establishing the plurality of updates, the automatic performance encoded in software:
updating the logical relationship information using the plurality of updates corresponding to the one or more defined logical relationships.

2. The method of claim 1, further comprising:
sorting the plurality of updates according to one or more dataset groups; and
placing the plurality of updates into one or more update sets, each update set comprising the plurality of updates for each dataset group of the one or more dataset groups.

3. The method of claim 1, further comprising sorting the plurality of updates according to one or more predefined parameters.

4. The method of claim 1, further comprising sorting the plurality of updates according to one or more user parameters.

5. The method of claim 1, further comprising notifying a user that the automatically performing step is complete.

6. The method of claim 1, wherein establishing the plurality of updates further comprises:
receiving a new address for the second segment of the plurality of segments;
identifying a defined logical relationship associated with the second segment; and
generating an update corresponding to the identified defined logical relationship, the generated update reflecting the new address.

7. The method of claim 1, wherein:
the logical relationship information comprises a prefix indicating the location of the second segment of the one or more databases;
updating the logical relationship information further comprises changing the prefix in accordance with an update corresponding to a defined logical relationship associated with the second segment.

8. A system for updating logical relationship information describing one or more defined logical relationships among a plurality of segments of one or more databases, comprising:
a memory operable to store the logical relationship information describing the one or more defined logical relationships among the plurality of segments of the one or more databases, the plurality of segments comprising a first segment and a second segment of the one or more databases, a defined logical relationship representing a logical relationship between the first segment and the second segment, a segment comprising a unit of information of a database of the one or more databases; and
a processor operable to:
access the logical relationship information;
establish a plurality of updates corresponding to the one or more defined logical relationships, an update operable to update the logical relationship information; and
automatically perform the following in parallel in response to establishing the plurality of updates, the automatic performance encoded in software:
update the logical relationship information using the plurality of updates corresponding to the one or more defined logical relationships.

9. The system of claim 8, wherein the processor is further operable to:
sort the plurality of updates according to one or more dataset groups; and
place the plurality of updates into one or more update sets, each update set comprising the plurality of updates for each dataset group of the one or more dataset groups.

10. The system of claim 8, wherein the processor is further operable to sort the plurality of updates according to one or more predefined parameters.

11. The system of claim 8, wherein the processor is further operable to sort the plurality of updates according to one or more user parameters.

12. The system of claim 8, wherein the processor is further operable to notify a user that the automatically performing step is complete.

13. The system of claim 8, wherein the processor operable to establish plurality of updates further comprises a processor operable to:
receive a new address for the second segment of the plurality of segments;
identify a defined logical relationship associated with the second segment; and
generate an update corresponding to the identified defined logical relationship, the generated update reflecting the new address.

14. The system of claim 8, wherein:
the logical relationship information comprises a prefix indicating the location of the second segment of the one or more databases;
the processor operable to automatically perform comprises a processor operable to change the prefix in accordance with an update corresponding to a defined logical relationship associated with the second segment.

15. Logic for updating logical relationship information describing one or more defined logical relationships among a plurality of segments of one or more databases, the logic embodied in a medium and operable to:
access the logical relationship information describing the one or more defined logical relationships among the plurality of segments of the one or more databases, the plurality of segments comprising a first segment and a second segment of the one or more databases, a defined logical relationship representing a logical relationship between the first segment and the second segment, a segment comprising a unit of information of a database of the one or more databases;
establish a plurality of updates corresponding to the one or more defined logical relationships, an update operable to update the logical relationship information; and
automatically perform the following in parallel in response to establishing the plurality of updates, the automatic performance encoded in software:
update the logical relationship information using the plurality of updates corresponding to the one or more defined logical relationships.

16. The medium of claim 15, wherein the code is further operable to:
sort the plurality of updates according to one or more dataset groups; and
place the plurality of updates into one or more update sets, each update set comprising the plurality of updates for each dataset group of the one or more dataset groups.

17. The medium of claim 15, wherein the code is further operable to:
sort the plurality of updates according to one or more predefined parameters.

18. The medium of claim 15, wherein the code is further operable to:
sort the plurality of updates according to one or more user parameters.

19. The medium of claim 15, wherein the code is further operable to:
notify a user that the automatically performing step is complete.

20. The medium of claim 15, wherein the code is further operable to:
receive a new address for the second segment of the plurality of segments;
identify a defined logical relationship associated with the second segment; and
generate an update corresponding to the identified defined logical relationship, the generated update reflecting the new address.

21. The medium of claim 15, wherein:
the logical relationship information comprises a prefix indicating the location of the second segment of the one or more databases;
the code operable to update the logical relationship information comprises a code operable to change the prefix in accordance with an update corresponding to a defined logical relationship associated with the second segment.

22. A system for updating logical relationship information describing one or more defined logical relationships among a plurality of segments of one or more databases, comprising:
means for accessing the logical relationship information describing the one or more defined logical relationships among the plurality of segments of the one or more databases, the plurality of segments comprising a first segment and a second segment of the one or more databases, a defined logical relationship representing a logical relationship between the first segment and the second segment, a segment comprising a unit of information of a database of the one or more databases;
means for establishing a plurality of updates corresponding to the one or more defined logical relationships, an update operable to update the logical relationship information; and
means for automatically performing the following in parallel in response to establishing the plurality of updates, the automatic performance encoded in software:
updating the logical relationship information using the plurality of updates corresponding to the one or more defined logical relationships.

23. A method for updating logical relationship information describing one or more defined logical relationships among a plurality of segments of one or more databases, comprising:
accessing the logical relationship information describing the one or more defined logical relationships among the plurality of segments of the one or more databases, the plurality of segments comprising a first segment and a second segment of the one or more databases, a defined logical relationship representing a logical relationship between the first segment and the second segment, a segment comprising a unit of information of a database of the one or more databases, the logical relationship information comprises a prefix indicating the location of the second segment of the one or more databases;
establishing a plurality of updates corresponding to the one or more defined logical relationships, an update operable to update the logical relationship information, establishing the plurality of updates comprising:
receiving a new address for the second segment of the plurality of segments;
identifying a defined logical relationship associated with the second segment; and
generating an update corresponding to the identified defined logical relationship, the generated update reflecting the new address.
sorting the plurality of updates according to one or more dataset groups; and
placing the plurality of updates into one or more sets, each set comprising the plurality of updates for each dataset group of the one or more dataset groups.
sorting the plurality of updates according to one or more predefined parameters;
sorting the plurality of updates according to one or more user parameters;
automatically performing the following in parallel in response to establishing the plurality of updates, the automatic performance encoded in software:
updating the logical relationship information using the plurality of updates corresponding to the one or more defined logical relationships, updating the logical relationship information comprising:
changing the prefix in accordance with an update corresponding to a defined logical relationship associated with the second segment; and
notifying a user that the automatically performing step is complete.
